(19) United States
(12) Patent Application Publication
(10) Pub. No.: US 2025/0346755 A1
(43) Pub. Date: Nov. 13, 2025

(54) PEEK Compositions with Reduced Crystallization Rate

(71) Applicant: DUPONT SAFETY & CONTSTRUCTION, INC., WILMINGTON, DE (US)

(72) Inventors: KATHLEEN OPPER, GREENVILLE, DE (US); NATALIE FRANK, RICHMOND, VA (US); LAURA E. CLINGER, WILMINGTON, DE (US); MATTHEW S. HALL, RICHMOND, VA (US)

(21) Appl. No.: 19/190,066

(22) Filed: Apr. 25, 2025

Related U.S. Application Data
(60) Provisional application No. 63/645,380, filed on May 10, 2024.
(60) Provisional application No. 63/772,054, filed on Mar. 14, 2025.

(51) Int. Cl. C08L 71/00; C08J 3/00; C09D 171/00

(52) U.S. Cl. CPC C08L 71/00; C08J 3/005; C09D 171/00; C08J 2371/08; C08J 2377/10; C08L 2203/30

(57) ABSTRACT

A composition comprising a) 3 to 20 parts by weight particles comprising aramid copolymer including an imidazole group, and b) 80 to 97 parts by weight of polyether ether ketone polymer; based on the total weight of a) and b) in the composition, and a process for making same, wherein the particles have either a particle size that will pass through a mesh screen having square openings, wherein each side of the square opening is nominally 354 micrometers, but the particles are retained on a square mesh screen wherein each side of the square opening is nominally 125 micrometers; or a particle size that will pass through a mesh screen having square openings, wherein each side of the square opening is nominally 125 micrometers. The composition is suitable for use in additive printing and manufacturing.

### BACKGROUND OF THE INVENTION

### Field of the Invention

This invention relates to polyether ether ketone (PEEK) compositions that are suitable as a hot melt for additive manufacturing or 3D printing processes, or any other process, wherein it is desirable for the crystallization rate of the PEEK composition to be reduced.

### Description of Related Art

The crystallization rate of a molten polymer is an important variable in additive manufacturing processes, also including processes known as 3D printing. These processes can involve the deposition of successive molten polymer layers, and for cohesion of the layers, the reptation and interlayer intermingling of polymer chains before crystallization is desirable. Without sufficient layer to layer cohesion, the z-direction properties suffer, and parts may not meet use requirements. With slower polymer crystallization, it is believed there is more time for layer-to-layer intermingling and better mechanical properties result.

PEEK is a desirable material for hot melt for additive manufacturing or 3D printing processes but has a very fast crystallization rate; faster than other poly(aryl ether ketone) s such as polyether-ketone (PEK) or polyether-ether-ketone-ketone (PEEKK) (for example, see pg. 51 of K. Könnecke (1994) Crystallization of Poly(aryl ether ketones). I. Crystallization Kinetics, Journal of Macromolecular Science, Part B, 33:1, 37-62.

Previous compositional technology to lower this crystallization rate has involved using copolymers of PEEK. However, the introduction of comonomers can lower the crystallinity of the final polymer, affecting mechanical and impact properties, and in many instances the comonomers are more expensive than PEEK, making them undesirable.

Therefore, what is needed are other potential ways to reduce the crystallization rate of PEEK without appreciably affecting the overall crystallinity of the final polymer.

### BRIEF SUMMARY OF THE INVENTION

This invention relates to a composition comprising a) 2 to 20 parts by weight particles comprising aramid copolymer including an imidazole group, and b) 80 to 98 parts by weight of polyether ether ketone polymer; based on the total weight of a) and b) in the composition, wherein the particles have either a particle size that will pass through a mesh screen having square openings, wherein each side of the square opening is nominally 354 micrometers, but the particles are retained on a mesh screen having square openings, wherein each side of the square opening is nominally 125 micrometers; or a particle size that will pass through a mesh screen having square openings, wherein each side of the square opening is nominally 125 micrometers.

This invention also relates to a process for making a composition comprising the steps of
a) providing particles comprising aramid copolymer including an imidazole group, wherein said particles have either a particle size that will pass through a mesh screen having square openings, wherein each side of the square opening is nominally 354 micrometers, but the particles are retained on a mesh screen having square openings, wherein each side of the square opening is nominally 125 micrometers; or a particle size that will pass through a mesh screen having square openings, wherein each side of the square opening is nominally 125 micrometers;
b) forming a mixture of said particles with molten polyether ether ketone polymer, wherein the mixture comprises
   i) 2 to 20 parts by weight of said particles, and
   ii) 80 to 98 parts by weight of the polyether ether ketone polymer; based on the total weight of i) and ii) in the mixture,
wherein said particles are dispersed in the molten polyether ether ketone polymer.

### DETAILED DESCRIPTION OF THE INVENTION

It has been found that a composition comprising poly(ether-ether-ketone) (PEEK) polymer and polymer particles of a very low particle size, wherein the polymer of the polymer particles comprises an aramid copolymer including an imidazole group, can slow the crystallization of PEEK; that is, can reduce the polymer crystallization rate from a molten to a solid state. This is counterintuitive, as powder additives in polymers typically act as nucleating sites to speed up polymer crystallization rate. Additionally, these PEEK compositions containing small polymer particles are also suitable for use in hot melt type 3D “inks”, because of the need for fine resolution in much 3D printing. Additionally, the reduced crystallization rate of the PEEK is believed to contribute to improved 3D printed or additive manufactured part properties, allowing more intermingling of polymer chains between printed layers of the PEEK polymer composition.

As used herein, the term 3D “ink”, or the phrase “hot melt for additive manufacturing” is intended to include any flowable composition suited for additive manufacturing a part of object. The preferred 3D “ink” is of a hot melt type.

Specifically, the PEEK composition comprises 2 to 20 parts by weight particles comprising aramid copolymer including an imidazole group. These particles are dispersed in 80 to 98 parts by weight of polyether ether ketone polymer; based on the total weight of a) and b) in the composition. In some embodiments, the particles made from an aramid copolymer comprising an imidazole group have a particle size that will pass through a mesh screen having square openings, wherein each side of the square opening is nominally 354 micrometers, but the particles are retained on a mesh screen having square openings, wherein each side of the square opening is nominally 125 micrometers. In some other embodiments, the particles made from an aramid copolymer comprising an imidazole group have a particle size that will pass through a mesh screen having square openings, wherein each side of the square opening is nominally 125 micrometers.

In some embodiments, the PEEK composition comprises at least 3 parts by weight of the particles comprising aramid copolymer including an imidazole group; in some embodiments, the PEEK composition comprises at least 5 parts by weight of the particles comprising aramid copolymer including an imidazole group; and in some other embodiments the PEEK composition comprises at least 10 parts by weight of the particles comprising aramid copolymer including an imidazole group, all based on the total weight of said particles and PEEK polymer in the composition.

In some embodiments, the PEEK composition comprises at least 85 parts by weight of the polyether ether ketone polymer; based on the total weight of said particles and PEEK polymer in the composition. In some embodiments, the PEEK composition comprises at least 85 parts by weight of the polyether ether ketone polymer; in some embodiments, the PEEK composition comprises at least 90 parts by weight of the polyether ether ketone polymer; in some embodiments, the PEEK composition comprises at least 95 parts by weight of the polyether ether ketone polymer, and in still other embodiments, the PEEK composition comprises at least 97 or 98 parts by weight of the polyether ether ketone polymer, all based on the total weight of said particles and PEEK polymer in the composition.

It is believed some especially useful ranges can include 2 to 20 parts by weight of the aramid copolymer particles and 80 to 98 parts by weight of the PEEK polymer; 3 to 20 parts by weight of the aramid copolymer particles and 80 to 97 parts by weight of the PEEK polymer; 2 to 10 parts by weight of the aramid copolymer particles and 90 to 98 parts by weight of the PEEK polymer; 3 to 10 parts by weight of the aramid copolymer particles and 90 to 97 parts by weight of the PEEK polymer; 5 to 10 parts by weight of the aramid copolymer particles and 90 to 95 parts by weight of the PEEK polymer; 5 to 15 parts by weight of the aramid copolymer particles and 85 to 95 parts by weight of the PEEK polymer; and 10 to 20 parts by weight of the aramid copolymer particles and 80 to 90 parts by weight of the PEEK polymer, all based on the total weight of said particles and PEEK polymer in the composition.

It is believed that the growth rate of crystallization of PEEK polymer becomes a maximum between the glass transition temperature of PEEK (typically about 143° C.) and the melt temperature of PEEK (typically 343° C.). The PEEK composition comprising the PEEK polymer and the polymer particles of a very low particle size, as described herein, has a crystallization rate, when cooled under nitrogen from a molten state to a temperature higher than the glass transition temperature of the PEEK polymer, that is less than the rate of crystallization of polyether ether ketone polymer by itself, when cooled in the same manner. The amount of crystallization rate change is considered herein to be the percent difference in the Corrected Peak Exothermic Time (CPET) between the PEEK composition and PEEK polymer itself, as further described and shown herein. In some embodiments, the PEEK composition can have a crystallization rate, when cooled under nitrogen from a molten state at 306° C. or 308° C. or higher, that is less than the rate of crystallization of polyether ether ketone polymer by itself, when cooled in the same manner. In some embodiments, the PEEK composition can have a crystallization rate, when cooled under nitrogen from a molten state to a temperature that is 306° C. to 322° C., that is less than the rate of crystallization of polyether ether ketone polymer by itself, when cooled in the same manner.

This reduction in rate of crystallization rate is believed to provide a hot melt, a hot melt 3D “ink”, or other molten composition that can produce improved parts and articles using additive manufacturing processes. In some embodiments, the rate of crystallization of the PEEK composition is reduced by at least 3.45% versus the rate of crystallization of PEEK polymer by itself. In other embodiments, the rate of crystallization of the PEEK composition is reduced by at least 5% versus the rate of crystallization of PEEK polymer by itself. In still other embodiments, the rate of crystallization of the PEEK composition is reduced by at least 10% versus the rate of crystallization of PEEK polymer by itself. All of these reductions in crystallization rate are determined by comparing the CPET of the PEEK composition to just the PEEK polymer by itself, when both are cooled in the same manner under nitrogen from a molten state (typically at least 343° C. or higher) to a temperature of from 306° C. to 322° C.

An additional benefit of the present PEEK composition is that the addition of the aramid copolymer particles does not result in a significant negative impact on crystallinity. In the most preferred embodiments, the crystallinity of the PEEK composition is the same or higher than the crystallinity of the PEEK itself. In some embodiments, the PEEK composition has a crystallinity that is within 6 percent of the crystallinity of the PEEK itself. In other embodiments, the PEEK composition has a crystallinity that is within 3 percent of the crystallinity of the PEEK itself, and in some desired embodiments the PEEK composition has a crystallinity that is within 2 percent of the crystallinity of the PEEK itself.

It is also believed that parts and articles comprising the PEEK composition can additionally have improved wear resistance due to the use of the particles comprising aramid copolymer including an imidazole group as described herein in the PEEK composition.

By poly(ether-ether-ketone) (PEEK) polymer, it is meant the thermoplastic homopolymer having the general formula of C₁₉H₁₂O₃ and having a melting point of around 343° C. The general structure of PEEK has a repeat unit as follows, with n being the number of repeat units:

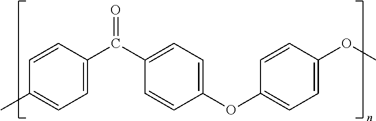

In some embodiments, the PEEK has a melt viscosity of from about 70 Pascal-seconds (Pa-s) to about 450 Pa-s, according to ISO11443, measured at a shear rate of 1000^{-s} and a temperature of 400° C. In some preferred embodiments the PEEK has a melt viscosity of about 100 Pa-s to about 400 Pa-s, and in some embodiments the PEEK has a melt viscosity of about 130 Pa-s to about 350 Pa-s, all measured at a shear rate of 1000^{-s} and 400° C.

The term “polymer,” as used herein, means a material prepared by polymerizing monomers, end-functionalized oligomers, and/or end-functionalized polymers whether of the same or different types. The term aramid, as used herein, means aromatic polyamide, wherein at least 85% of the amide (—CONH—) linkages are attached directly to two aromatic rings.

The term “aramid copolymer including an imidazole group” as used herein refers to copolymers prepared from aromatic diacids and diamines wherein there are at least two different diamines present, those being an aromatic diamine and an imidazole diamine. The two different diamines can be polymerized with a stoichiometric amount of one or more aromatic diacids.

Of the aromatic diacids, para-oriented aromatic diacids are preferred and the most preferred para-oriented aromatic diacid is terephthaloyl dichloride. Likewise, of the aromatic diamines, para-oriented aromatic diamines are preferred, and the preferred para-oriented aromatic diamine is paraphenylene diamine.

By “imidazole diamine”, it is meant a diamine having at least one imidazole group. Preferably, the imidazole diamine is a benzimidazole. In some preferred embodiments the imidazole diamine is 5(6)-amino-2-(p-aminophenyl)benzimidazole (DAPBI). In some preferred embodiments the aramid copolymer is made by polymerizing the monomers 5(6)-amino-2-(p-aminophenyl)benzimidazole, aromatic diamine(s), and aromatic diacid-chloride(s). In some most preferred embodiments, the aramid copolymer is made by polymerizing the monomers 5(6)-amino-2-(p-aminophenyl)benzimidazole, paraphenylene diamine, and terephthaloyl dichloride.

In some embodiments, the molar ratio of imidazole diamine, such as 5(6)-amino-2-(p-aminophenyl)benzimidazole, to the aromatic diamine is 50/50 to 80/20. In some specific embodiments, the aramid copolymer including an imidazole group includes a residue of 5(6)-amino-2-(p-aminophenyl)benzimidazole and a residue of paraphenylene diamine, wherein the molar ratio of the residue of 5(6)-amino-2-(p-aminophenyl)benzimidazole to the residue of paraphenylene diamine is 50/50 to 80/20. In some specific embodiments, the aramid copolymer including an imidazole group includes a residue of 5(6)-amino-2-(p-aminophenyl)benzimidazole and a residue of paraphenylene diamine, wherein the molar ratio of the residue of 5(6)-amino-2-(p-aminophenyl)benzimidazole to the residue of paraphenylene diamine is 50/50 to 70/30.

In still other embodiments, the imidazole diamine, such as 5(6)-amino-2-(p-aminophenyl)benzimidazole, is 50 mole percent or greater of the total moles of imidazole diamine and the aromatic diamine present.

As used herein, “stoichiometric amount” means the amount of a component theoretically needed to react with all of the reactive groups of a second component. For example, “stoichiometric amount” refers to the moles of terephthaloyl dichloride needed to react with substantially all of the amine groups of the amine components. It is understood by those skilled in the art that the term “stoichiometric amount” refers to a range of amounts that are typically within 10% of the theoretical amount. For example, the stoichiometric amount of terephthaloyl dichloride used in a polymerization reaction can be 90-110% of the amount of terephthaloyl dichloride theoretically needed to react with all of the amine groups.

In some embodiments, all of monomers can be combined together and reacted to form the polymer. In some embodiments, the monomers or various amounts of the monomers can be reacted sequentially to form oligomers which can be further reacted with additional monomer(s) or oligomer(s) to form polymers. By “oligomer,” it is meant polymers or species eluting out at <3000 MW with a column calibrated using poly(paraphenylene terephthalamide) homopolymer.

As used herein, the term “residue” of a chemical species refers to the moiety that is the resulting product of the chemical species in a particular reaction scheme or subsequent formulation or chemical product, regardless of whether the moiety is actually obtained from the chemical species. Thus, a copolymer comprising residues of paraphenylene diamine refers to a copolymer having one or more units of the formula:

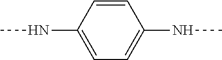

And a copolymer having residues of terephthaloyl dichloride contains one or more units of the formula:

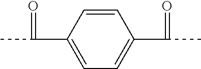

Similarly, a copolymer comprising residues of an imidazole group such as a benzimidazole group contains one or more units of the formula:

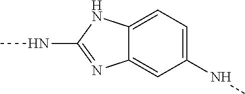

And specifically, a copolymer comprising residues of DAPBI contains one or more units of the formula:

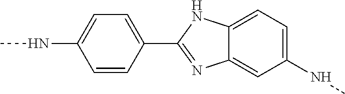

Therefore, in some embodiments, the aramid copolymer includes a residue of a benzimidazole, and in some embodiments the aramid copolymer includes a residue of 5(6)-amino-2-(p-aminophenyl)benzimidazole.

The aramid copolymer including an imidazole group can be made in accordance with the teachings of United States Patent Publication 20130018138. This can provide a copolymer in the form of a water-wet acid crumb, which can be rough ground while wet using various types of size-reduction equipment, including such equipment as hammer mills, disk mills, roll mills. The acid crumb is then preferably neutralized by washing with a base and then the neutralized crumb is isolated. The neutralized crumb can then be dried to form polymer particles that have an irregular size and that a majority thereof will pass through a mesh screen having 1.4 mm openings. These particles are referred to herein as “raw polymer” particles. In some preferred embodiments, the specific raw polymer particles are made by the polymerization of the monomers 5(6)-amino-2-(p-aminophenyl)benzimidazole, paraphenylene diamine, and terephthaloyl dichloride.

The size of the aramid copolymer particles described herein can preferably be determined by classifying using any industrial method of sieving particles preferably using screens. An alternate method, generally used for very small particles, is by laser diffraction using DIN ISO 13320-2020, which can also determine fine particle diameters and their distribution.

A typical method of sieving particles uses a column of sieve trays of wire mesh screens of a graded mesh size. The material to be classified is poured onto the top sieve tray, which has the largest screen openings in the column. Each lower sieve tray in the column has smaller openings than the one above. The column of sieves trays is typically placed in a mechanical shaker, which shakes all the sieve trays in the column to facilitate movement of the particles on the surface of each mesh screen in each tray so that particles small enough to fit through the screen openings can fall through to the next sieve tray by gravity. After the shaking is complete, the particles remaining on each mesh screen of each sieve tray have a particle size too large to pass through the openings in that mesh screen.

While there are various systems of identifying the mesh sizes such as US Standard or Tyler mesh, herein any screen sizes are identified by their openings in millimeters to avoid confusion. Additionally, as used herein, the openings in the screen are assumed to be square openings; for example, a mesh screen having 0.125 mm openings has openings that are square, and each side of the square opening is nominally 0.125 mm.

Particles made with aramid copolymer including an imidazole group that are suitable for use in some embodiments have a particle size that will pass through a mesh screen having square openings, wherein each side of the square opening is nominally 354 micrometers, but the particles are retained on a mesh screen having square openings, wherein each side of the square opening is nominally 125 micrometers. In some preferred embodiments, these particles have a particle size distribution wherein the d50 is 267 μm (+/−25 μm), the d10 is 125 μm (+/−25 μm), and d90 is 481 μm (+/−25 μm).

Still other particles made with aramid copolymer including an imidazole group that are suitable for use in some preferred embodiments have a particle size that will pass through a mesh screen having square openings, wherein each side of the square opening is nominally 125 micrometers. In some preferred embodiments, these particles have a particle size distribution wherein the d50 is 91 μm (+/−25 μm), d10 is 44 μm (+/−25 μm), and d90 is 183 μm (+/−25 μm).

Particles made with aramid copolymer including an imidazole group of the desired size can be obtained by simply classifying the raw aramid copolymer to obtain the desired fraction of particle sizes. Alternatively, the raw aramid copolymer particles can be comminuted or ground to further reduce their particle size prior to classifying and use in the PEEK composition. Such size reducing processes can include variants of the hammer mills, disk mills, roll mills, and the like, and other processes such as jet mills and twin-screw extruders.

This invention also relates to a process for making a composition comprising the steps of
a) providing particles comprising aramid copolymer including an imidazole group, wherein said particles have either a particle size that will pass through a mesh screen having square openings, wherein each side of the square opening is nominally 354 micrometers, but the particles are retained on a mesh screen having square openings, wherein each side of the square opening is nominally 125 micrometers; or a particle size that will pass through a mesh screen having square openings, wherein each side of the square opening is nominally 125 micrometers;
b) forming a mixture of said particles with molten polyether ether ketone polymer, wherein the mixture comprises
   i) 3 to 20 parts by weight of said particles, and
   ii) 80 to 97 parts by weight of the polyether ether ketone polymer; based on the total weight of i) and ii) in the mixture,
wherein said particles are dispersed in the molten polyether ether ketone polymer.

Preferably, the particles are uniformly dispersed in the PEEK polymer. By uniformly dispersed, it is meant the particles are preferably uniformly distributed in the PEEK polymer in a random manner that can preferably provide uniform mechanical properties to any article made from the PEEK composition.

In some embodiments, the process further comprises the step of
c) cooling the mixture into a solid or allowing the mixture to cool into a solid.

In some embodiments, the process utilizes:
i) 5 to 15 parts by weight of said particles, and
ii) 85 to 95 parts by weight of the polyether ether ketone polymer;
based on the total weight of i) and ii) in the mixture.

The process utilizes the PEEK polymer and the aramid copolymer including an imidazole group as previously described herein. In some embodiments, the aramid copolymer including an imidazole group includes a residue of 5(6)-amino-2-(p-aminophenyl)benzimidazole; and in some embodiments, the aramid copolymer including an imidazole group further includes a residue of paraphenylene diamine.

In one preferred embodiment, the molar ratio of the residue of 5(6)-amino-2-(p-aminophenyl)benzimidazole to the residue of paraphenylene diamine is 50/50 to 80/20; and in a very preferred embodiment the molar ratio of the residue of 5(6)-amino-2-(p-aminophenyl)benzimidazole to the residue of paraphenylene diamine is 50/50 to 70/30.

As previously discussed herein, the composition comprising poly(ether-ether-ketone) (PEEK) polymer and polymer particles of a very low particle size slows the crystallization of PEEK composition from a molten to solid state. In many embodiments, the PEEK composition has a crystallization rate, when cooled under nitrogen from a molten state to a temperature higher than the glass transition temperature of the PEEK polymer, that is less than the rate of crystallization of polyether ether ketone polymer by itself, when cooled in the same manner. In some embodiments, the PEEK composition can have a crystallization rate, when cooled under nitrogen from a molten state at 306° C. or 308° C. or higher, that is less than the rate of crystallization of polyether ether ketone polymer by itself, when cooled in the same manner.

Articles can be made that comprise the PEEK composition wherein the aramid copolymer particles are the sole particulate incorporated into the PEEK composition, optionally further containing a pigment. In some other embodiments, the articles could include a PEEK composition containing the aramid copolymer particles, an optional pigment, and one or more additional type(s) of particulate, as long the additional type(s) of particulate has (have) a minimal or desirable effect on the article's desired properties. In some other embodiments, the articles include a PEEK composition wherein the aramid copolymer particles are the majority (greater than 50 wt. %) particulate additive by weight of the total amount of particulate additives in the PEEK composition that is not a pigment or a filler. In still some other embodiments, the articles include a PEEK composition wherein the aramid copolymer particles are the majority (greater than 50 wt. %) particulate additive by weight of the total amount of particulate additives in the PEEK composition.

The PEEK composition described herein is believed suitable for use as a hot melt for additive manufacturing, extrusion molding, or injection molding to make articles. In many embodiments, the preferred articles are parts made from the PEEK composition when in a molten state, such extruded parts, injection molded parts, and parts made by extrusion additive manufacturing. Extrusion additive manufacturing processes include fused filament fabrication (“FFF”) processes and other material extrusion processes. The PEEK composition in a molten state can also be used in processes such as 3-D printing, fused deposition modeling (FDM); or the PEEK composition can be fashioned into filaments and those filaments then used in applications that use such filaments in additive manufacturing. All of these processes can be used to manufacture devices, parts, and prototypes. Such parts can be, for example, thin-walled parts or industrial large format parts for use in the automotive and/or aerospace industry.

It is believed that the inventive polyether ether ketone polymer compositions described herein can improve the break strength of articles such as extruded parts, injection molded parts, and parts made by extrusion additive manufacturing, as compared to such articles made solely from a neat polyether ether ketone polymer, by 2 percent or greater, or 5 percent or greater, and preferably 10 percent or greater, with that improvement in break strength ranging from those values up to 20 percent, up to 30 percent, or greater. In some embodiments, the improvement in break strength is perpendicular to the print path. It is believed the break strength in other orientations to the print path can also be improved. As used herein, “neat” polyether ether ketone polymer is considered to be a polyether ether ketone polymer that does not contain the aramid copolymer particles described herein.

### Test Methods

Differential Scanning calorimetry. A DSC procedure was used to measure the crystallization time and crystallinity of the examples at varying temperatures, using a TA Instruments Discovery DSC 2500. The profile of the test is to heat the sample at 40° C./min to 380° C. until melted, hold isothermally for 3 minutes, cool at 20° C./min to a temperature of interest, and hold isothermally for 90 minutes before final cooling to 50° C. at 40° C./min. This sequence is repeated on the same pan for varying temperatures of interest, increasing by 2° C. from 306° C. to 322° C., under a nitrogen atmosphere. The step to melt the material at the beginning erases the thermal history from the previous run.

Particle Size Distribution. Particle size distribution was determined by laser diffraction, samples were measured in the dry powder state in triplicate and the average of 3 runs is reported. D10, D50, & D90 are particle sizes in micrometers at which 10%, 50%, and 90% of the particles are smaller than the listed particle size (by volume %). In other words, a D50 of X microns means that 50 volume percent of particles in the distribution has a diameter smaller than X microns. As used in the context of a particle size distribution, the term particle size is equivalent to an average particle diameter. The D50 is equivalent to the median particle size of the sample.

### EXAMPLES

The aramid copolymer particles used in the following examples were made as follows. The aramid copolymer was made with the monomers 5(6)-amino-2-(p-aminophenyl)benzimidazole (DAPBI) and paraphenylene diamine (PPD), in amounts suitable for forming a copolymer having a DABPI/PPD monomer ratio of 70/30, which were combined with a stoichiometric amount of terephthaloyl dichloride (TCI) in a solvent system comprising N-methyl-2-pyrrolidone (NMP) solvent and 4.5 weight percent calcium chloride (CaCl2) as a solubility enhancer. The monomers polymerized to form a copolymer.

After the polymerization was complete, the copolymer crumb was recovered and ground, and then washed with sodium hydroxide to neutralize byproduct hydrochloric acid to form an undried neutral crumb, which was then dried. The copolymer had an inherent viscosity of about 6.4 dl/g. As the crumb was dried, the fines were collected on a screen. The particle fines were further size classified using a series of sieves, specifically a 500 micron screen, followed by 354 micron screen, followed by 125 micron screen. The aramid copolymer particles used in examples passed through a 500 micron screen, and particle fractions PF1, PF2, and PF3 were obtained that:
PF3: passed through the 500 micron screen, retained on the 354 micron screen;
PF2: passed through the 354 micron screen, retained on the 125 micron screen;
PF1: passed through the 125 micron screen.

### Examples 1 to 4 and Comparison Examples A to D

The aramid copolymer particles and PEEK polymer were combined using a Brabender Intelli-Torque Plasti-Corder® equipped with a large mixing bowl and cam blades. The PEEK polymer was either Victrex™ PEEK 150 G or Victrex™ PEEK 450 G and the aramid copolymer particles were selected from particle fractions PF1, PF2, and PF3. The PEEK polymer was dried overnight at 140° C. under vacuum with a flow of nitrogen.

For each sample made, the initial bowl temperature was set to 360° C. Once the unit was at temperature, the rotors were turned on to 100 RPM. For Examples 1 to 4 and Comparison Examples B & D, 54 grams of the PEEK polymer was added to the bowl and allowed to melt for 1 minute, followed by the addition of 6 grams of one of the aramid copolymer particle fractions (10% by weight), followed by 5 minutes of mixing time (total 6 minutes). For Comparison Examples A and C, 60 grams of PEEK polymer was added to the bowl and allowed to melt and mix for 6 minutes without the addition of any aramid copolymer particles.

The temperature control was then reduced to 300° C. The rotor was turned to 50 RPM and the sample was allowed to cool until it could be handled. Each sample was then collected into a metal pan and flattened into a disk to promote additional cooling.

Examples 1 & 2 and Comparison Examples A & B utilized the Victrex™ PEEK 150 G polymer. Example 1 further contained aramid copolymer particle fraction PF1, while Example 2 contained aramid copolymer particle fraction PF2. Comparison Example A was made with only the PEEK polymer and contained no aramid copolymer particles. Comparison Example B was made the same as Examples 1 & 2, except the aramid copolymer particle fraction was PF3.

Examples 3 & 4 and Comparison Examples C & D utilized the Victrex™ PEEK 450 G polymer. Example 3 further contained aramid copolymer particle fraction PF1, while Example 4 contained aramid copolymer particle fraction PF2. Comparison Example C was made with only the PEEK polymer and contained no aramid copolymer particles. Comparison Example D was made the same as Examples 3 & 4, except the aramid copolymer particle fraction was PF3.

Samples were then analyzed by DSC per the test method. Approximately 10 mg samples were cut from the flattened chunks of material. The discs were compressed at 1000 psi into a 3 mm disc at room temperature using a controlled 3 mm diameter mold. The disc was weighed and trimmed to approximated 5.5 mg then taken and loaded into a Tzero aluminum DSC pan. The weight of the samples was kept within a 0.5 mg window to ensure the same signal strength was detected on all tests. The pans were sealed using a hermetic punch.

Crystallization Time was then determined for the samples as follows. The heat flow isothermal data from the 90-minute hold in the DSC procedure was charted as a function of time using Trios analytical software. The time of peak heat flow was obtained using the “Signal Max” analysis function. This is the time of most exothermic energy during the crystallization phase transition and will be referred to as the Raw Peak Exothermic Time. The time of lowest heat flow before the start of crystallization was measured using the “Signal Min” analysis function and is termed the Signal Min Time. The lowest Signal Min Time in a temperature set is subtracted from the Raw Peak Exothermic Time to find the Corrected Peak Exothermic Time (CPET). This calculation is repeated for all examples. The Corrected Peak Exothermic Times (in minutes) are summarized in Table 1.

The Corrected Peak Exothermic Time for the samples increased as the isothermal temperature rose in all examples. Therefore, as temperature increases the crystallization time increases. The change in crystallization time (A) with respect to the comparative example of the same base material with 0% filler (A for PEEK150 g and C for PEEK450 g) was calculated according to the following equation for each temperature:

$$Δ = \frac{Example X CPET - 0 \% Filler Comparative Example CPET}{0 \% Filler Comparative Example CPET} \times 100$$

The change (Δ) in crystallization time for all samples is shown in Table 2. With particle fractions PF1 and PF2, the crystallization time for Examples 1 and 3 was increased across all temperatures. There is a higher magnitude of time increase as the isothermal temperature increased. In contrast, the samples with particle fractions PF3; that is, Examples B & D, reduced the crystallization time at most temperatures.

TABLE 1
Corrected Peak Exothermic Time (CPET) (in minutes)

| Isothermal | | | | | | | | |
|---|---|---|---|---|---|---|---|---|
| Hold | | | | | | | | |
| Temperature | PEEK150 g Base Material | | | | PEEK450 g Base Material | | | |
| (degC.) | A | 1 | 2 | B | C | 3 | 4 | D |
| 306 | 0.25 | 0.24 | 0.21 | 0.23 | 0.64 | 0.69 | 0.66 | 0.66 |
| 308 | 0.31 | 0.30 | 0.27 | 0.27 | 0.92 | 0.96 | 0.98 | 0.90 |
| 310 | 0.40 | 0.40 | 0.35 | 0.35 | 1.32 | 1.37 | 1.44 | 1.29 |
| 312 | 0.55 | 0.56 | 0.49 | 0.46 | 1.93 | 2.00 | 2.14 | 1.88 |
| 314 | 0.76 | 0.81 | 0.70 | 0.66 | 2.81 | 2.92 | 3.16 | 2.74 |
| 316 | 1.11 | 1.21 | 1.06 | 0.97 | 4.09 | 4.20 | 4.54 | 3.99 |
| 318 | 1.66 | 1.84 | 1.62 | 1.45 | 5.96 | 6.16 | 6.91 | 5.79 |
| 320 | 2.52 | 2.76 | 2.50 | 2.19 | 8.54 | 9.09 | 10.50 | 8.73 |
| 322 | 3.82 | 4.18 | 3.78 | 3.35 | 12.97 | 13.83 | 14.67 | 12.90 |

TABLE 2
Change (Δ) in Crystallization Time

| Isothermal | | | | | | |
|---|---|---|---|---|---|---|
| Hold | PEEK150 g Base Material | | | PEEK450 g Base Material | | |
| Temperature | (w/respect to A) | | | (w/respect to C) | | |
| (degC.) | 1 | 2 | B | 3 | 4 | D |
| 306 | 0.00% | 12.50% | −4.17% | 4.55% | 3.03% | 0.00% |
| 308 | 3.45% | 10.34% | −6.90% | 3.23% | 2.15% | 3.23% |
| 310 | 5.26% | 10.53% | −7.89% | 3.79% | 3.79% | 2.27% |
| 312 | 9.80% | 11.76% | −9.80% | 4.17% | 3.65% | 2.08% |
| 314 | 14.08% | 12.68% | −7.04% | 5.04% | 5.04% | 1.44% |
| 316 | 16.35% | 11.54% | −6.73% | 3.70% | 2.96% | 1.48% |
| 318 | 18.71% | 10.97% | −6.45% | 6.21% | 5.52% | 0.17% |
| 320 | 18.97% | 10.78% | −5.60% | 5.82% | 5.36% | 1.63% |
| 322 | 19.77% | 10.03% | −4.01% | 7.96% | 7.10% | 0.70% |

The crystallinity of the samples was also measured to determine if the particles had any impact on final crystallinity. The heat flow data from the step 2 ramp of the DSC procedure was charted as a function of temperature using the Trios analytical software. The “Peak Integration (enthalpy)” analysis function was used to calculate the heat of melting (ΔHₘ) for the samples after each temperature ramp. The results from the ramp before the 306° C. isothermal hold were excluded as it shows the crystallinity of the material before erasing its thermal history. Crystallinity was calculated using the below equation:

$$Crystallinity = \frac{Δ Hm}{Δ {Hm}_{o}} \times 100$$

### Where:

ΔHm=measured heat of melting [J/g]
ΔHmₒ=theoretical heat of melting for 100% crystalline material [J/g] (130 J/g for PEEK)

The theoretical heat of melting was multiplied by a factor of 0.9 for calculations where 10% of the composition was replaced by fillers. The crystallinity of the materials decreases as isothermal hold temperature increases, however, examples containing fillers maintained crystallinity levels equivalent to those of the 100% PEEK examples. Data is shown in Table 3.

TABLE 3
Crystallinity

| Isothermal Hold | | | | | | | | |
|---|---|---|---|---|---|---|---|---|
| Temperature | PEEK150 g Base Material | | | | PEEK450 g Base Material | | | |
| (degC.) | A | 1 | 2 | B | C | 3 | 4 | D |
| 306 | 34.2% | 38.7% | 35.5% | 36.2% | 31.9% | 31.0% | 33.8% | 31.6% |
| 308 | 40.6% | 41.3% | 40.4% | 40.4% | 36.2% | 36.0% | 36.2% | 34.8% |
| 310 | 40.4% | 41.1% | 39.8% | 40.7% | 36.2% | 35.9% | 36.0% | 34.9% |
| 312 | 40.0% | 40.4% | 39.1% | 39.9% | 35.8% | 35.7% | 35.7% | 34.9% |
| 314 | 39.0% | 39.9% | 38.3% | 39.6% | 35.7% | 35.3% | 35.2% | 34.6% |
| 316 | 38.2% | 38.9% | 37.5% | 38.8% | 34.1% | 34.4% | 35.1% | 34.1% |
| 318 | 37.7% | 38.5% | 36.8% | 38.2% | 33.3% | 33.4% | 33.4% | 33.1% |
| 320 | 36.8% | 37.4% | 35.9% | 37.1% | 32.2% | 32.7% | 31.7% | 32.0% |
| 322 | 36.1% | 36.4% | 34.1% | 36.0% | 30.8% | 31.1% | 31.2% | 31.0% |

### Examples 5 to 10 and Comparison Example E

These examples illustrate that other particle loadings can reduce the crystallization time of PEEK polymer. The procedure described for Example 1, 2, and Comparison A, utilizing the Victrex™ PEEK 150 G polymer, was repeated; however, for Examples 5, 6, and 7, PEEK 150 G polymer in the amount of 57.6, 55.2, and 54 grams, respectively, was combined with 2.4, 4.8, and 6 grams, respectively, of the aramid copolymer particle fraction PF1. This resulted in samples having 4, 8, and 10% aramid copolymer particles by weight. Examples 8, 9, and 10 repeated this procedure to make samples having the PEEK 150 G polymer and aramid copolymer particles; however, for these examples, the aramid polymer particle fraction was PF2. Comparison Example E repeated the procedure as described for Comparison A and was made with only the PEEK 150 G polymer and contained no aramid copolymer particles.

The Corrected Peak Exothermic Times (in minutes) for these samples are summarized in Table 4, and the change (A) in crystallization time for these samples is shown in Table 5.

TABLE 4
Corrected Peak Exothermic Time (CPET) (in minutes)

| Isothermal | | | | | | | |
|---|---|---|---|---|---|---|---|
| Hold | No | | | | | | |
| Temperature | Particles | PF1 Particle Fraction | | | PF2 Particle Fraction | | |
| (degC.) | E | 5 | 6 | 7 | 8 | 9 | 10 |
| 306 | 0.24 | 0.21 | 0.22 | 0.26 | 0.25 | 0.33 | 0.31 |
| 308 | 0.29 | 0.27 | 0.29 | 0.32 | 0.31 | 0.40 | 0.38 |
| 310 | 0.38 | 0.37 | 0.38 | 0.42 | 0.40 | 0.50 | 0.47 |
| 312 | 0.51 | 0.49 | 0.52 | 0.60 | 0.54 | 0.66 | 0.62 |
| 314 | 0.71 | 0.72 | 0.77 | 0.85 | 0.76 | 0.89 | 0.85 |
| 316 | 1.04 | 1.05 | 1.13 | 1.26 | 1.12 | 1.28 | 1.22 |
| 318 | 1.55 | 1.55 | 1.70 | 1.89 | 1.62 | 1.85 | 1.81 |
| 320 | 2.32 | 2.32 | 2.60 | 2.85 | 2.44 | 2.76 | 2.69 |
| 322 | 3.49 | 3.54 | 3.89 | 4.26 | 3.64 | 4.13 | 4.02 |

TABLE 5
Change (Δ) in Crystallization Time

| Isothermal | | | | | | |
|---|---|---|---|---|---|---|
| Hold | | | | | | |
| Temperature | PF1 Particle Fraction | | | PF2 Particle Fraction | | |
| (deg C.) | 5 | 6 | 7 | 8 | 9 | 10 |
| 306 | −12.50% | −8.33% | 8.33% | 4.17% | 37.50% | 29.17% |
| 308 | −6.90% | 0.00% | 10.34% | 6.90% | 37.93% | 31.03% |
| 310 | −2.63% | 0.00% | 10.53% | 5.26% | 31.58% | 23.68% |
| 312 | −3.92% | 1.96% | 17.65% | 5.88% | 29.41% | 21.57% |
| 314 | 1.41% | 8.45% | 19.72% | 7.04% | 25.35% | 19.72% |
| 316 | 0.96% | 8.65% | 21.15% | 7.69% | 23.08% | 17.31% |
| 318 | 0.00% | 9.68% | 21.94% | 4.52% | 19.35% | 16.77% |
| 320 | 0.00% | 12.07% | 22.84% | 5.17% | 18.97% | 15.95% |
| 322 | 1.43% | 11.46% | 22.06% | 4.30% | 18.34% | 15.19% |

### Example 11

This example provides evidence that the change in crystallization time resulting from the addition of the copolymer particles improves z-direction tensile properties, thus confirming better cohesion between printed layers of the PEEK polymer. Victrex™ PEEK 150 G polymer and aramid copolymer particles having the PF1 particle fraction, in a weight ratio of 90/10, were combined using a twin-screw extruder that extruded a molten strand of the composite composition; that strand was thermally quenched and made into pellets. Likewise, control pellets were made from the same PEEK polymer without any aramid copolymer particles.

A sample of each of the pellets was then extruded, using a single-screw extruder, into a monofilament for FDM (Fused Deposition Modeling). The FDM monofilament for each composition was then 3D printed into Type IV dog bone-shaped samples (tensile bars-3 each for each composition) with the print direction perpendicular to the pull axis of tensile bars, to attain Z-direction properties.

For all dog-bone shaped samples, the printing nozzle temperature was 440° C. and the bed temperature was 150° C., with an ambient temperature of about 80 to 100° F. The dog-bone shaped samples were printed flat, with 6 outline layers, with the outline overlap being 20% and leaving no gaps. The mechanical properties of the 3D printed dog bone-shaped samples were then measured using ASTM method D638-22 “Standard Test Method for Tensile Properties of Plastics”, and the results are summarized in Table 6. As shown, the composite composition had unexpectedly higher break stress, showing a break stress improvement of 13%. Also, the increased break strain (elongation) and reduced modulus were also unexpected, resulting in an improvement in calculated energy density of about 119 percent, indicating a tougher material results from the addition of the aramid copolymer.

TABLE 6
Z-Direction Mechanical Properties

| | Break | Break Stress | Break | Energy | |
|---|---|---|---|---|---|
| | Stress | Improvement | Strain | Density | Modulus |
| Item | (MPa) | (%) | % | J/cm³ | (MPa) |
| Control | 6.8 | — | 0.77 | 0.027 | 899 |
| Example 11 | 7.7 | 13 | 1.44 | 0.059 | 594 |

1. A composition, comprising:
a) 2 to 20 parts by weight particles comprising aramid copolymer including an imidazole group, and
b) 80 to 97 parts by weight of polyether ether ketone polymer;
based on the total weight of a) and b) in the composition,
wherein the particles have either:
a particle size that will pass through a mesh screen having square openings, wherein each side of the square opening is nominally 354 micrometers, but the particles are retained on a mesh screen having square openings, wherein each side of the square opening is nominally 125 micrometers; or
a particle size that will pass through a mesh screen having square openings, wherein each side of the square opening is nominally 125 micrometers.

2. The composition of claim 1 comprising:
a) 5 to 15 parts by weight of the particles comprising aramid copolymer including an imidazole group, and
b) 85 to 95 parts by weight of the polyether ether ketone polymer;
based on the total weight of a) and b) in the composition.

3. The composition of claim 1 having a crystallization rate, when cooled from a molten state to a temperature higher than the glass transition temperature of the polyether ether ketone polymer, that is less than the rate of crystallization of polyether ether ketone polymer by itself, when cooled in the same manner.

4. The composition of claim 1 wherein the aramid copolymer including an imidazole group includes a residue of 5(6)-amino-2-(p-aminophenyl)benzimidazole.

5. The composition of claim 4 wherein the aramid copolymer including an imidazole group further includes a residue of paraphenylene diamine.

6. The composition of claim 5 wherein the molar ratio of the residue of 5(6)-amino-2-(p-aminophenyl)benzimidazole to the residue of paraphenylene diamine is 50/50 to 80/20.

7. The composition of claim 6 wherein the molar ratio of the residue of 5(6)-amino-2-(p-aminophenyl)benzimidazole to the residue of paraphenylene diamine is 50/50 to 70/30.

8. A hot melt suitable for additive manufacturing, extrusion molding, or injection molding comprising the composition of claim 1.

9. An article comprising the composition of claim 1.

10. The article of claim 9 having a break strength 2 percent or greater than the break strength of an article made solely from neat polyether ether ketone polymer.

11. The article of claim 10, wherein the break strength is 5 percent or greater.

12. The article of claim 11, wherein the break strength is 10 percent or greater.

13. A process for making a composition comprising the steps of
a) providing particles comprising aramid copolymer including an imidazole group, wherein said particles have either;
a particle size that will pass through a mesh screen having square openings, wherein each side of the square opening is nominally 354 micrometers, but the particles are retained on a mesh screen having square openings, wherein each side of the square opening is nominally 125 micrometers; or
a particle size that will pass through a mesh screen having square openings, wherein each side of the square opening is nominally 125 micrometers;
b) forming a mixture of said particles with molten polyether ether ketone polymer, wherein the mixture comprises
i) 3 to 20 parts by weight of said particles, and
ii) 80 to 97 parts by weight of the polyether ether ketone polymer;
based on the total weight of i) and ii) in the mixture,
wherein said particles are dispersed in the molten polyether ether ketone polymer.

14. The process of claim 13, comprising:
i) 5 to 15 parts by weight of said particles, and
ii) 85 to 95 parts by weight of the polyether ether ketone polymer;
based on the total weight of i) and ii) in the mixture.

15. The process of claim 13 wherein the aramid copolymer including an imidazole group includes a residue of 5(6)-amino-2-(p-aminophenyl)benzimidazole.

16. The process of claim 15 wherein the aramid copolymer including an imidazole group further includes a residue of paraphenylene diamine.

17. The process of claim 16 wherein the molar ratio of the residue of 5(6)-amino-2-(p-aminophenyl)benzimidazole to the residue of paraphenylene diamine is 50/50 to 80/20.

18. The process of claim 17 wherein the molar ratio of the residue of 5(6)-amino-2-(p-aminophenyl)benzimidazole to the residue of paraphenylene diamine is 50/50 to 70/30.

19. The process of claim 13, wherein the molten mixture has a crystallization rate, when cooled from the molten state to a temperature higher than the glass transition temperature of the polyether ether ketone polymer, that is less than the rate of crystallization of polyether ether ketone polymer by itself, when cooled in the same manner.

20. The process of claim 13, further comprising
c) cooling the mixture into a solid or allowing the mixture to cool into a solid.
